(19) United States
(12) Patent Application Publication
(10) Pub. No.: US 2023/0294200 A1
(43) Pub. Date: Sep. 21, 2023

(54) MACHINE AND METHOD FOR TREATING PARTS OF DIFFERENT SHAPES

(71) Applicants: HYDROMECANIQUE ET FROTTEMENT, Andrezieux-Boutheon (FR); UNIVERSITE JEAN MONNET SAINT ETIENNE, Saint-Etienne (FR); CENTRE NATIONAL DE LA RECHERCHE SCIENTIFIQUE, Paris, (FR)

(72) Inventors: Christophe Heau, Saint-Jean-Bonnefonds (FR); Philippe Maurin-Perrier, Saint-Marcellin-En-Forez (FR); Florence Garrelie, Saint-Etienne (FR); Jean-Philippe Colombier, Saint-Heand (FR); Florent Pigeon, Saint-Etienne (FR)

(21) Appl. No.: 18/014,030

(22) PCT Filed: Jun. 3, 2021
(86) PCT No.: PCT/FR2021/051010

§ 371 Date: Dec. 30, 2022

(30) Foreign Application Priority Data
Jul. 31, 2020 (FR) 2008151

(51) Int. Cl. B23K 26/00; B01J 19/08; B01J 19/12

(52) U.S. Cl. CPC B23K 26/0093; B01J 19/088; B01J 19/121; B01J 2219/0879

(57) ABSTRACT

This invention relates to a machine for treating parts with different shapes, comprising a chamber); a vacuum system; treatment systems, including a plasma generating system and/or a vacuum deposition system; and a transport system which is capable of displacing the part or parts in the chamber irrespectively of the shape of these parts; characterized in that the treatment systems include a laser system which is designed to treat the part or parts disposed in the chamber.

### TECHNICAL FIELD

The present invention relates to a machine for the treatment of parts with different shapes. The invention also concerns a treatment method. The field of the invention is that of surface treatment.

### PRIOR ART

A variety of machines are known for the treatment of the surface of parts. However, existing machines are often designed for a single type of treatment (vacuum deposition, for example). Other machines combine several treatments, but are designed for a single shape for a part (film or disk, for example).

WO 2009/053614 A2 describes an example of a treatment machine comprising a chamber, a vacuum system, a plasma generating system, a vacuum deposition system and a system for transporting parts.

### DISCLOSURE OF THE INVENTION

The aim of the present invention is to improve the versatility of the machine in respect of the proposed treatments.

To this end, the objective of the invention is to provide a machine for the treatment of parts of different shapes, comprising a chamber; a vacuum system; treatment systems, including a plasma generating system and/or a vacuum deposition system; and a transport system which is capable of displacing the part or parts in the chamber, whatever the shape of these parts. The machine is characterized in that the treatment systems include a laser system designed to treat the part or parts disposed in the chamber. Thus, the invention makes it possible to improve the versatility of the machine and to vary the proposed treatments. The parts are processed by one or other of the treatment systems in succession, possibly in combination, in a manner such that the operator can create and select their own sequences of treatments. The operator may elect to use the systems in one order or another, to repeat certain treatments, and so on.

The machine may be configured in different manners in order to treat small parts (of the order of 1 to 10 cm) or large parts (of the order of 0.1 to 1 m, or more).

Furthermore, the treated parts may be made from different materials: metals, ceramics, composites, plastics, etc.

In accordance with other advantageous features of the invention, taken individually or in combination:
The treatment systems may be used selectively to treat the part or parts, either separately from the other systems or simultaneously with one or more of the other systems.
The sequence of use of the treatment systems can be set, with a variable order of use and/or a variable number of uses.
The treatment systems may be used to treat the part or parts directly.
The laser system is distinct from the plasma generating system.
The machine comprises a system for protecting the laser system, more precisely of the window enabling the laser beam to enter the chamber.
The protection system comprises a movable cover in front of the laser system.
The protection system comprises a transparent film which runs in front of the laser system.
The protection system comprises internal walls which optically isolate the path of the laser beam originating from the laser system from the remainder of the chamber, and which protect from fluxes originating from the treatment systems.
The protection system comprises a chamber fixed to a wall of the chamber and formed between the window of the laser system and the parts to be treated, this chamber being provided with an aperture facing the parts in order to define an aperture angle of less than 45 degrees between the window and the chamber.
The laser system comprises a single laser source.
The laser system comprises a plurality of laser sources.
The laser system comprises one or more pulsed laser sources, for example with pulse durations of the order of femtoseconds, picoseconds or nanoseconds.
The laser source is mono-spectral.
The laser source is multi-spectral (selection of wavelength as a function of the material).
The laser sources are identical (same wavelength, same pulse duration, same polarisation, same beam shape).
The laser sources are different (different wavelengths and/or pulse durations and/or polarisation and/or beam shapes).
The laser beam may have multiple vector polarisation states (for example azimuthal, radial, vortex polarisation, etc.).
The laser beam may be orientated with an oblique or orthogonal incidence onto the part or parts.
The transport system is capable of displacing the part or parts in a manner such that two successive treatment zones are contiguous.
The laser system comprises a device for correcting the path and/or the shape and/or for focussing the laser beam.
The transport system comprises a turntable intended to support one or more parts.
The transport system comprises turrets mounted on the turntable and intended to receive one or more parts.
The turrets are movable in rotation with respect to the turntable.
The transport system comprises turntables rotatably mounted on the turrets and intended to support the parts.
The laser system is disposed laterally.
The transport system comprises a longitudinal transport device intended to support one or more parts. The device may be a carriage, a roller conveyor, a conveyor belt, or any other suitable means.
The transport system comprises a position-encoding device.
The transport system comprises visual marks and an optical sensor which is capable of cooperating with the marks.

The invention also provides a method for the treatment of parts with different shapes, the method comprising:
a) a step for vacuuming a chamber in which the part or parts are located, then a combination of the following steps:
b) a step for laser treatment of the part or parts, and
c) a step for low pressure plasma treatment of the part or parts, and/or
d) a step for carrying out vacuum deposition on one or more of the parts.

The method is characterized in that the different steps a), b), c) and/or d) are carried out in the same machine which is adapted to treat parts with different shapes.

The steps b), c) and d) may be carried out selectively, either separately from the other steps or simultaneously with one or more of the other steps, in order to treat the part or parts.

Advantageously, steps b), c), d) or combinations thereof may be carried out in accordance with a sequence of use which can be set, with a variable order of uses and/or a variable number of uses.

### DESCRIPTION OF THE FIGURES

The invention will be better understood from the following description, which is given solely by way of non-limiting example and is made with reference to the accompanying drawings, showing the following diagrammatic views:

FIG. 1 is a plan view of a machine in accordance with the invention, equipped with a rotary transport system.

FIG. 2 is a side view of the machine of FIG. 1, showing the transport system equipped with turrets and the laser system disposed laterally.

FIG. 3 is a view analogous to FIG. 1, showing a variation of the transport system.

FIG. 4 is a view analogous to FIG. 2, showing another variation of the transport system and a variation of the laser system.

FIG. 5 is a side view, showing another machine in accordance with the invention, equipped with a longitudinal transport system.

FIG. 6 is an elevation (side view or top view, depending on the machine), showing a first solution for a laser system protection system.

FIG. 7 is a view analogous to FIG. 6, showing this first protection system solution in another position.

FIG. 8 is a view analogous to FIG. 6, showing a second solution for a laser system protection system.

FIG. 9 is a view analogous to FIG. 8, showing this second protection system solution in motion.

FIG. 10 is a view analogous to FIG. 6, on a smaller scale, showing a third solution for the laser system protection system in accordance with a first configuration.

FIG. 11 is a view analogous to FIG. 10, showing this third protection system solution in accordance with a second configuration.

FIG. 12 is a view analogous to FIG. 10, showing this third protection system solution in accordance with a third configuration.

FIG. 13 is a view analogous to FIG. 10, showing the protection system in accordance with the first configuration, in use.

FIG. 14 shows a view analogous to FIG. 11, showing the protection system in accordance with the second configuration, in use.

FIG. 15 is a view analogous to FIG. 12, showing the protection system in accordance with the third configuration, in use.

FIG. 16 is an elevation (side view or top view) of a laser system, showing a fourth solution for a laser system protection system.

FIG. 17 is a view of a cylindrical part and of the incident laser beam, showing the defocussing and deformation of the laser beam spot on the part.

FIG. 18 is a perspective view of a cylindrical part and of the incident laser beam, showing a case of oblique incidence and the deformation of the spot of the laser beam on the part.

FIG. 19 is a view analogous to FIG. 18, showing a zone to be treated which is contiguous with a previously treated zone.

### DETAILED DESCRIPTION OF THE INVENTION

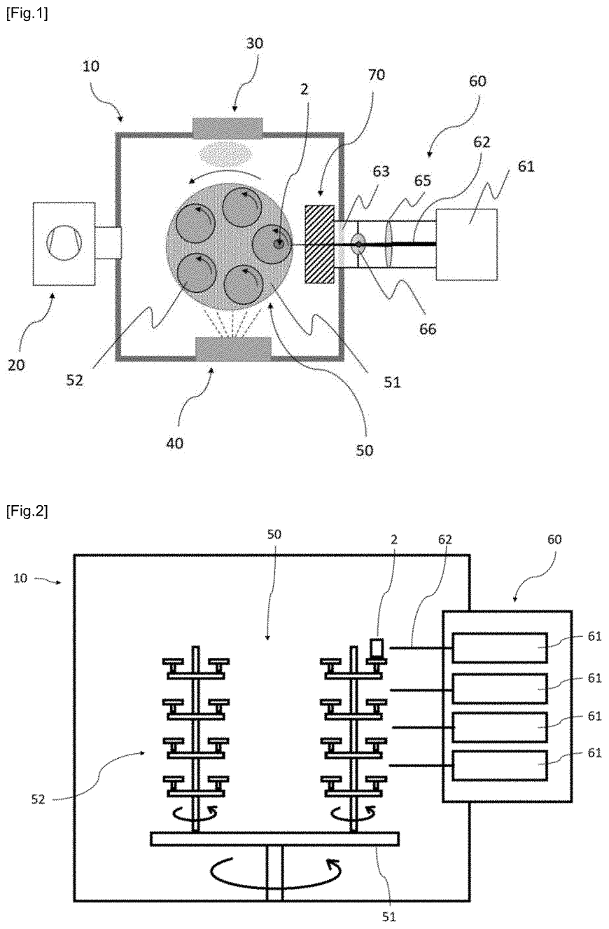

FIGS. 1 and 2 show a machine (1) in accordance with the invention, designed for the treatment of parts (2) with different shapes.

In the context of the invention, the expression “with different shapes” includes parts with different geometries and/or dimensions. This expression is not limited to parts having the same geometry but different dimensions, for example flat films of different widths. The machine (1) is adapted to treat both parts with a flat shape, i.e. with a very small thickness (less than 5%) compared with the other dimensions, and bulky parts, i.e. with three dimensions of the same order of magnitude or having a similar order of magnitude. The parts may be bodies of revolution (for example cylinders), or indeed parallelepipeds. Finally, the parts may be of irregular shape, i.e. solids composed of surfaces which are not necessarily orthogonal to each other, or which have sides of unequal dimensions. The machine (1) in accordance with the invention is designed to carry out surface treatments on the parts (2). Surface treatments form part of the Applicants field of expertise, and may include, but are not limited to, the following treatments: chemical deposition of a thin film, activation, stripping or cleaning, texturing (i.e. the production of relief motifs on the surface of the part, these motifs having dimensions of the order of one nanometre up to one tenth of a metre), heat treatment (i.e. the modification of the crystalline structure of a metal via a predetermined temperature cycle).

These treatments are termed surface treatments, or superficial treatments, insofar as the zone of effect of these treatments is limited to at most a few tenths of millimetres below the surface of the part, and they are not aimed at treating a part at the core, i.e. deep into the part so that the whole of the material has undergone the treatment.

The machine (1) comprises a chamber (10), a vacuum system (20), a plasma generating system (30), a vacuum deposition system (40), a transport system (50), a laser system (60) and a protection system (70).

Alternatively, the machine (1) may comprise a plasma generating system (30) but not a vacuum deposition system (40), or it may comprise a vacuum deposition system (40) but not a plasma generating system (30).

In general, such a machine (1) also comprises a heating system for degassing the parts (2) and the inside of the chamber (10) before any other treatment. The machine (1) also comprises a system for injecting pure gases or mixtures of gases in order to introduce the gases necessary for the treatments into the chamber (10) in a controlled manner. With the aim of simplification, neither the heating system nor the gas injection system is shown in the figures.

Advantageously, the systems (10-70) may be used separately or simultaneously with one or more of the other systems (10-70).
As an example, the operator may elect to use the laser system (60) while the chamber (10) is under vacuum, by using the vacuum system (20).
In accordance with another example, the operator may elect to carry out a treatment with the plasma system (30) on a first part (2) simultaneously with a treatment with the laser system (60) on a second part (2).

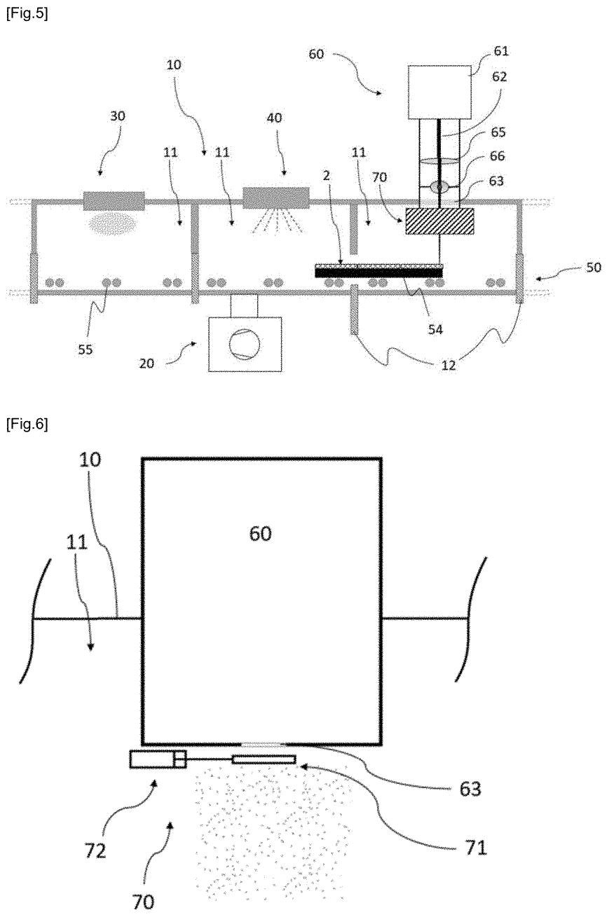

In addition, the order of use and the number of uses of the different systems (10-70) can be parameterized in accordance with different sequences:
As an example, the operator may elect to carry out a treatment with the laser system (60) and then displace the parts to the plasma treatment system (30).
In accordance with another example, the operator may elect to produce a first deposit using the vacuum deposition system (40), then carry out a laser treatment with the laser system (60), then produce a second deposit with the vacuum deposition system (40). The chamber (10) has a parallelepipedal shape, with two paired parallel horizontal walls constituting the top and the bottom of the chamber (10), as well as four parallel vertical walls constituting the sides of the chamber (10). Clearly, the walls may have different shapes without departing from the scope of the invention. As an example, it is possible to envisage a cylindrical chamber (10) comprising a single vertical cylindrical wall. This chamber (10) may comprise a single compartment (11), as shown in FIGS. 1 and 2, or a plurality of compartments (11), as shown in FIG. 5.

The vacuum system (20) is intended to evacuate the atmosphere present in the chamber (10). The system (20) may evacuate air, i.e. extract the air present in the chamber (10) so that the prevailing pressure may, for example, be from 10-2 to 10-9 Pa.

The plasma treatment system (30) may be used to strip the parts (2) in order to clean them with a view to a subsequent treatment. In addition, the system (30) may be used to activate a surface in a manner such that it can react to a further treatment, such as glow discharge cleaning for plastics or ceramics. In combination with the gas injection system, the plasma treatment system (30) may be used to produce PACVD (plasma assisted chemical vapour deposition) type deposits.

The vacuum deposition system (40) is intended to produce a deposit on the surface of the parts (2). As an example, the system (40) may be designed for a PACVD or PVD (physical vapour deposition) deposit. The vacuum deposition system (40) may optionally be used to strip the parts (2) if it provides sufficient ionized species, as is the case, for example, with an arc deposition source.

The transport system (50) is designed to receive the parts (2) and displace them in the chamber (10). This transport system (50) may be constructed in various manners. In the example of FIGS. 1 and 2, the system (50) comprises a turntable (51) rotating about a central vertical axis, and turrets (52) rotatably mounted on the turntable (51) about vertical axes parallel to the central axis, forming a carousel supporting one or more parts (2). The turrets (52) make it possible to exploit as much of the height of the chamber (10) as possible, in particular when treating small parts (2). The turntable (51) and the turrets (52) can rotate in the same direction or in opposite directions. The turrets (52) may be independently motorized, thereby allowing the turntable (51) and turrets (52) to be rotated separately or simultaneously. In a variation, the turrets (52) may be fixedly mounted on the turntable (51). In another variation, the turntable (51) may be free from turrets (52).

In accordance with the invention, the machine (1) is also equipped with a laser system (60), comprising a laser source (61) emitting a laser beam (62). The laser source (61) may be pulsed and emit pulses having durations of the order of femtoseconds, picoseconds or nanoseconds. The laser source (61) may be multi-spectral (wavelength selected as a function of the material).

As illustrated in FIG. 2, the laser system (60) may comprise a plurality of laser sources (61) so as to be able to treat a plurality of parts (2) at the same time, or a plurality of zones of a large part (2). The laser sources (61) may be identical (same wavelength, same pulse duration, same polarisation, same beam shape) or different (different wavelengths and/or pulse durations and/or polarisation and/or beam shapes). Reference will only be made below to “the” laser source (61), even if there may be several.

The laser system (60) comprises a window (63), which is optically transparent with respect to the beam (62), and which marks the transition between the laser system (60) and the chamber (10).

The system (60) comprises various optical devices, in particular a beam (62) focusing and correcting device (65), for concentrating the energy of the beam (62) at a selected distance from said device (65). It is necessary to modify the focussing when the parts (2) to be treated are of different dimensions, and when the distance between the surface of a part (2) and the laser system (60) is not the same from one part (2) to another.

The system (60) also comprises a deflection device (66) for orientating the laser beam (62) and scanning the surface of the part (2) to be treated.

The laser system (60) may be used in different manners and for different purposes:
Texturing, with removal of material from the part (2) in order to create cavities on the surface of the part (2). The cavities may be disposed in accordance with a discrete motif, i.e. the cavities are distinct from one another. Alternatively, the cavities may be disposed in accordance with a continuous motif, i.e. the cavities are connected to each other. In accordance with another alternative, the cavities may comprise a mixture of discrete and continuous motifs.
Nanotexturing without removal of material. In this embodiment, the pulses of the laser beam (62) cause a redistribution of the material and nanometric motifs are formed at the surface of the part. Depending on the operating conditions, the nanomotifs may be debossed, embossed or even both. This may be used in order to increase the specific surface area of the part (2), for example.
Surface treatment without removal of material, modifying the crystalline structure of the material.
Surface treatment without removal of material, modifying the topography of the material.
Chemical modification of the material, for example when the laser treatment is carried out in the presence of a pure reactive gas.

Other treatments may be carried out without departing from the scope of the invention. The machine (1) may also comprise a protection system (70) intended to protect the window (63) of the laser system. It is a fact that if the machine (1) advantageously combines the various treatment systems (20-60) detailed above, the result is that said systems may interfere with each other. In particular, the window (63) of the laser system (60) has to remain as transparent as possible in order to guarantee the effectiveness of the laser treatment. This loss of transparency may result from deposits on the window (63), originating from the material removed during laser texturing of the parts (2), or alternatively from the vacuum deposition system (40), or even from the plasma generating system (30). Protecting the window (63) may therefore be a major advantage for the machine (1), not only for the performance of the laser treatments to be carried out, but also in terms of the degree of availability of the machine (1), if the maintenance operations aimed at cleaning or replacing the window (63) are less frequent.

In practice, the machine (1) enables different methods to be implemented, including:
a) a step for evacuating the chamber (10), then a combination of the following steps:
b) a step for laser treatment of the parts (2), and
c) a step for plasma treatment of the parts (2), and/or
d) a step for carrying out vacuum deposition onto the parts (2).

Advantageously, the various steps a) to d) may be carried out in the same machine (1), adapted to treat parts (2) with different shapes with great versatility.

Steps a) and b) are always present in the method, supplemented by either step c), or step d), or both steps c) and d). The order of steps b), c) or d) is not chronological.

Step a) is prior to the other steps b), c) or d).

Steps b), c) and d) may be carried out selectively in order to treat the part or parts, either separately from the other steps or simultaneously with one or more of the other steps.

Steps b), c), d) or combinations thereof may be carried out in accordance with a sequence of use which can be parameterized, with a variable order of use and/or a variable number of uses. As an example, step b) may be carried out several times before carrying out step c) and/or d).

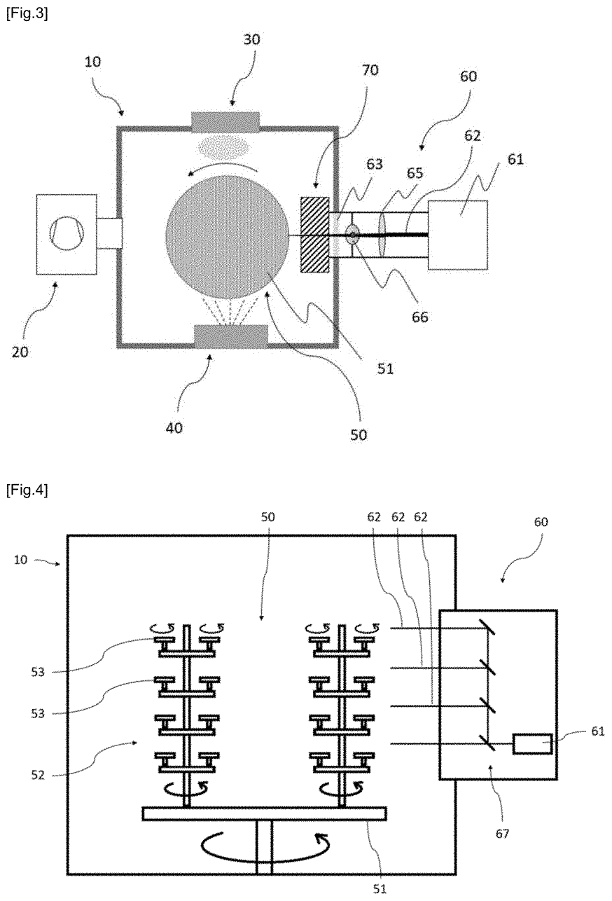

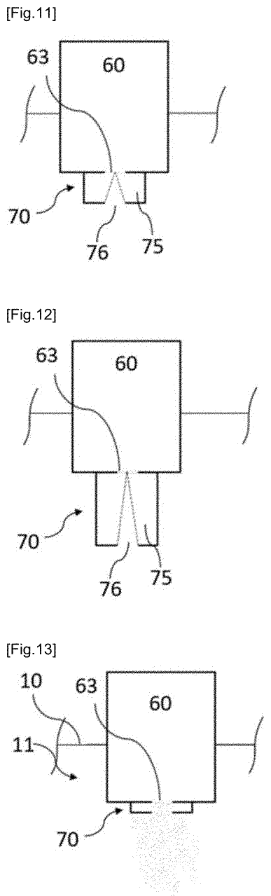

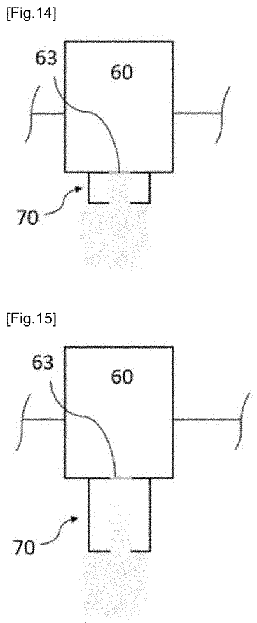

Other embodiments of a machine (1) in accordance with the invention are shown in FIGS. 3 to 17. Certain constituent elements of the machine (1) are comparable to those of the first embodiment described above and, with the aim of simplification, have the same numerical references.

FIG. 3 shows a transport system (50) solely comprising a turntable (51), without turrets (52). The turntable (51) forms a carousel on which one or more parts (2) are disposed. This configuration is advantageous when treating large parts (2).

FIG. 4 shows a laser system (60) provided with a single source (61) and with a device (67) for distributing and/or orientating the laser beam (62) in order to treat a plurality of small parts (2) simultaneously, or indeed several zones of the same large part (2). This distribution and/or orientation device (67) may be based on splitting the beam (62), for example by using semi-reflective mirrors as illustrated in FIG. 4, or in fact on a deflection of the beam (62), for example by using prisms which are rotated in such a manner that the facets of the prisms orientate the beam (62) successively in the direction of one zone (or one part) and then towards another. In the remainder of the document, reference will be made to the distribution device (67), without specifying whether it is a device for splitting or deflecting the beam (62).

When the transport system (50) comprises a carousel, the laser system (60) may advantageously be disposed laterally. Unlike machines (1) in which the laser system (60) is disposed at the top, this configuration makes it possible to treat what are known as “bulky” parts (2), in contrast to parts which are simply flat, such as disks or films, for example.

FIG. 4 also shows turrets (52) equipped with platens (53) which are themselves movable in rotation, so that three rotations could be controlled simultaneously or separately as a function of the requirements: turntable (51), turrets (52) and/or platens (53).

FIG. 5 shows another machine construction (1), comprising a longitudinal transport system (50) and a plurality of compartments (11).

The longitudinal transport system (50) comprises a carriage (54) supporting the parts (2) and rollers (55) supporting the carriage (54). Alternatively, the longitudinal transport system (50) may comprise a conveyor belt, a carriage-free roller conveyor (55), a carriage (54) associated with an endless screw, or any other suitable device.

The compartments (11) of the chamber (10) are separated by vertical internal walls provided with valves (12), allowing the adjacent compartments (11) to be partitioned off or made to communicate. This construction is advantageous for protecting one of the systems (20-60) from pollution generated by the use of one of the other systems. The plasma system (30) is mounted on the upper wall of a first compartment (11), the vacuum deposition system (40) is mounted on the upper wall of a second compartment (22), and the laser system (60) is mounted on the upper wall of a third compartment (11). Other configurations may be envisaged without departing from the scope of the invention.

Only one vacuum system (20) is shown, with a view to simplification. Such a machine (1) generally comprises a plurality of vacuum systems (20), because during a treatment, one compartment (11) may be isolated from the other compartments (11). This compartment (11) must then have its own system (20) for pumping. The same is true for the heating and gas injection systems.

FIGS. 6 to 16 show different variations of protection systems (70) for the laser system (60). Solutions intended to be integrated with the protection system (70) are numerous, and may be used in combination in order to take advantage of each of them and to increase the effectiveness of the resulting overall protection.

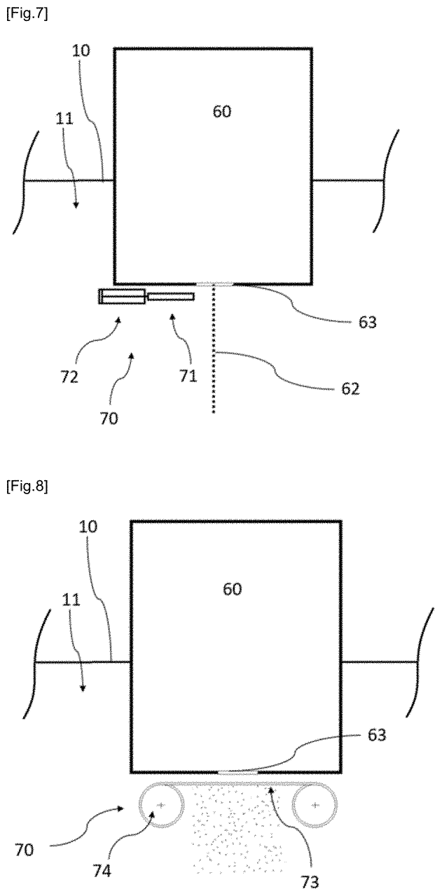

In FIGS. 6 and 7, the system (70) comprises a cover (71) in front of the window (63) and which is movable between an “open” position in which the cover (71) is distanced from the window (63) when the laser system (60) is in use, and a “closed” position in which the cover (71) is positioned in front of the window (63) when the laser system (60) is not in use while another system is in use. Thus, the duration of exposure of the window (63) to projections originating from other systems is reduced. This cover (71) may be a plate in the shape of the window (63), moved in translation by a cylinder (72). Any other relevant technical solution may also be considered, such as a diaphragm, for example.

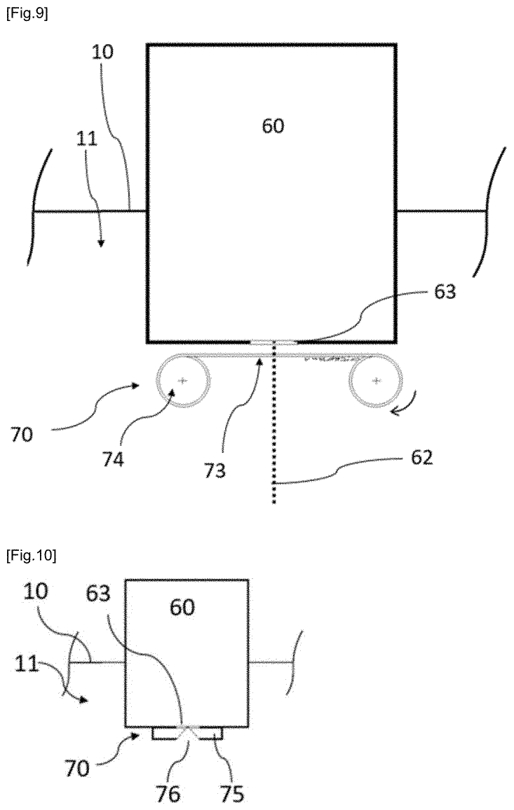

In FIGS. 8 and 9, the system (70) comprises a film (73) which is movable in front of the window (63) between two rollers (74). This film (73) must be optically transparent with respect to the beam (62) and perturb said beam (62) as little as possible. This film (73) is intended to collect the projections which may originate from the other systems (20-50), or from the parts (2) to be treated if texturing by removal is in progress. Advantageously, the operator may elect to leave the film (73) in the fixed position and to make it run past only when it is estimated that the film (73) has received too many projections, or in fact to make it run continuously in order to guarantee maximum transparency of the film (73) at all times. Automatic advance after a certain period of time may also be envisaged.

In FIGS. 10 to 15, the protection system (70) comprises a chamber (75) provided with an aperture (76) and disposed in front of the window (63). This is a geometrical solution aimed at increasing the distance between the window (63) and the aperture (76) through which the beam (62) enters the chamber (10). The chamber (75) defines a solid angle characterized by the ratio between the length of the chamber (75) and the width of the aperture (76). If this angle is too open, as shown in FIGS. 10 and 13, the projections originating from the treatments have no difficulty in penetrating into this chamber (75) and becoming deposited on the window (63). However, if the angle is closed, as illustrated in FIGS. 12 and 15, the chamber (75) constitutes a tunnel which the projections cannot access, thus preventing them from being deposited on the window (63). Preferably, the chamber (75) defines an aperture angle of less than 45 degrees between the window (63) and the aperture (76). More preferably, this aperture angle is the lateral aperture angle, as opposed to the vertical aperture angle.

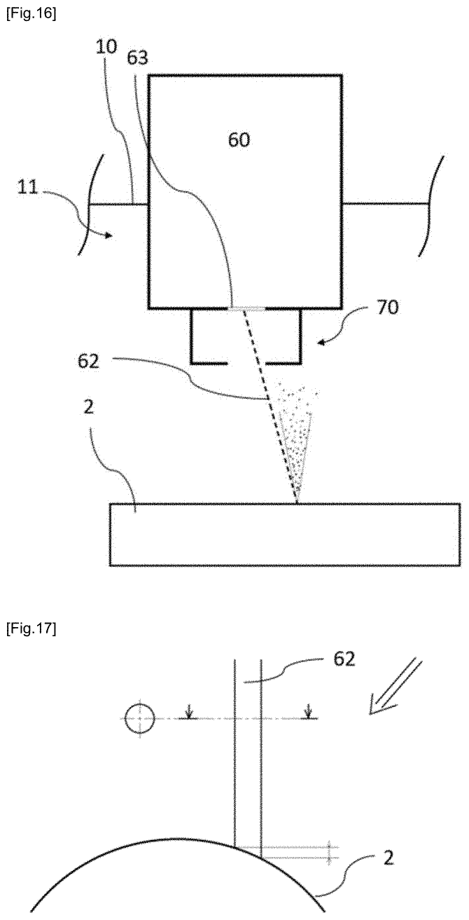

In FIG. 16, the protection system (70) is produced by providing an oblique angle between the beam (62) and the window (63), and an oblique angle of incidence between the laser beam (62) and the surface of the parts to be treated (2). In this manner, the projections deriving from texturing are emitted in a direction which is not that of the slit for the passage of the laser beam (62) through the window (63). Projections directed towards the window (63) are thus reduced, or even eliminated.

In a variation of this version of the protection system, an orthogonal angle of passage of the laser beam (62) through the window (63) is maintained and combined with an oblique incidence onto the surface of the part (2). This may be obtained, for example, by offsetting the laser beam (62) with respect to the centre of the turntable (51), or by inclining the window (63) with respect to the wall of the chamber (10).

In a variation, not shown, the protection system (70) may comprise walls disposed between the window (63) and the chamber (10) in order to optically isolate the path of the laser beam (62) and thereby protect the window (63) from projections.

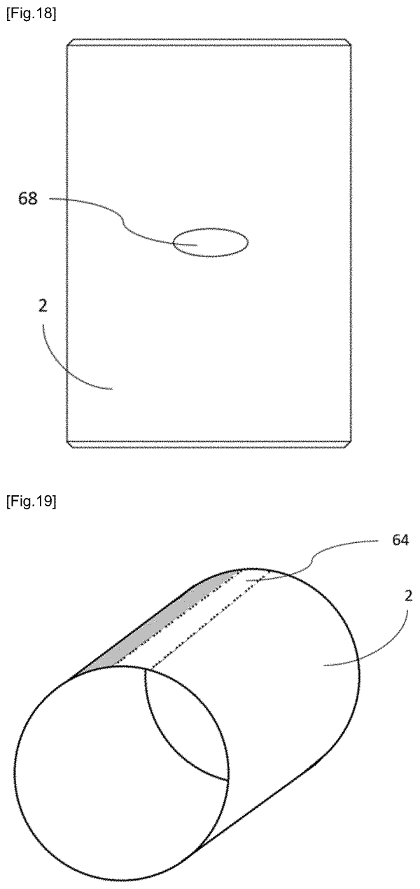

FIGS. 17 and 18 illustrate the advantage of providing the laser system (60) with a device for correcting the trajectory, focussing or shape. In particular, the device may be used in the treatment of parts (2) which do not have a surface which is orthogonal with respect to the beam (62). FIG. 17 shows a beam (62), projected onto a surface of the part (2) which is not orthogonal to the direction of the beam (2). To facilitate comprehension, the beam (62) is shown to be parallel and of circular section. It can be seen in FIG. 18 that the spot (68) resulting from projection of the beam (62) onto the part (2) is not a circle, but an ellipse. This is problematic, in particular if the purpose of the laser treatment is to obtain texturing comprising circular cavities. In this context, the correction device can be used to modify the shape of the laser beam (62) in order, as in this example, to correct the deformation induced by the surface. The laser system (60) may include a shaping module upstream of the correction device, for example in order to obtain predetermined non-circular structures.

FIG. 17 also shows that the location of the point of impact of the beam (62) on the part (2) has an impact on the distance to be covered between the spot (68) and the laser source (61). If the beam (62) is offset towards the right of the part (2), then the distance to be covered is greater. In reality, the beam (62) is not strictly parallel, but is convergent, so as to be focussed on the surface of the part (2). If the path to be travelled by the beam (62) has a variable length, then the focussing is lost. It is therefore appropriate to provide the system (60) with a device for correcting the focussing.

FIG. 19 shows a cylindrical part (2), part of which has already been treated, and a new zone (64) which is ready to be treated. Because the machine (1) may be intended to treat a large surface of one or more parts (2), this surface must be run past the system or systems (20-60) in use. The transport system (50) is therefore designed so as to displace the part (2) in a manner such that two successive treatment zones (64) are contiguous. This point will be illustrated in more detail by taking laser treatment as an example, although this feature of the transport system (50) may be implemented with the other systems (30, 40).

Carrying out a laser treatment implies that the surface of the part (2) must be positioned facing the window (63) of the laser system (60). The laser system (60) comprises complex optical devices requiring substantial mechanical adjustment and stability. The laser system casing (60) is fixed in position. The relative displacement of the beam (62) with respect to the part (2) is carried out by displacing the optical devices of the laser system (60) and/or by displacing the part (2) to be treated. As a result, the parts (2) are generally treated in successive zones (64), possibly with a plurality of zones (64) being treated in parallel by a plurality of laser beams (62). The laser system (60) treats the portion of the part (2) which is exposed to it. The part (2) is displaced so as to place the next zone to be treated facing the laser system (60). Preferably, this displacement is carried out simultaneously with the treatment in progress. Alternatively, this displacement may be carried out alternately with the treatment. This is illustrated in FIG. 19, where it may be seen that a portion of a cylindrical part (2) has already been treated and that a new zone (64) is ready to be treated.

The positioning accuracy of the part (2) may, for example, be increased by means of a position-encoding device comprising, for example, an encoder disposed within the kinematic chain which moves the turntable (51) or the carriage or carriages (54). Alternatively or in addition, visual marks which are capable of co-operating with one or more optical sensors may be provided. These visual marks may, for example, be marks made on the part (2) in a manner such as to be identified by a camera. It is also possible to envisage the visual marks being the zones which have already been treated, if these zones have a different colour or texture which may be detected by a sensor or by a camera with, for example, the use of a polarised light or light of a selected wavelength. The part (2) may be continuously movable with respect to the laser system (60), without this changing the interpretation of the arrangements explained above. The zone (64) being treated then has a smaller surface area which is refreshed far more frequently.

Moreover, the machine (1) may be configured differently from FIGS. 1 to 19 without departing from the scope of the invention, which is defined in the claims. Furthermore, the technical features of the various embodiments and variations mentioned above may be combined in their entirety or only in part. Thus, the machine (1) can be adapted in terms of cost, functions and performance.

1. A machine for treating parts of different shapes, comprising:
a chamber;
a vacuum system;
treatment systems, including a plasma generating system and/or a vacuum deposition system; and
a transport system which is capable of displacing the part or parts in the chamber, whatever the shape of these parts;
characterized in that the treatment systems include a laser system which is designed to treat the part or parts disposed in the chamber.

2. The machine according to claim 1, characterized in that the treatment systems can be used selectively for the treatment of the part or parts, either separately from the other systems or simultaneously with one or more of the other systems.

3. The machine according to claim 1, characterized in that the sequence of use of the treatment systems can be set, with a variable order of use and/or a variable number of uses.

4. The machine according to claim 1, characterized in that it comprises a protection system for the laser system.

5. The machine of claim 4, characterized in that the protection system comprises a cover which can be moved in front of the laser system.

6. The machine according to claim 4, characterized in that the protection system comprises a transparent film running in front of the laser system.

7. The machine according to claim 4, characterized in that the protection system comprises internal walls which optically isolate the path of the laser beam originating from the laser system from the remainder of the chamber, and which protects from fluxes originating from the treatment systems.

8. The machine according to claim 4, characterized in that the protection system comprises a chamber fixed to a wall of the chamber and formed between the window of the laser system and the parts to be treated, this chamber being provided with an aperture facing the parts in order to define an aperture angle of less than 45 degrees between the window and the chamber.

9. The machine according to claim 1, characterized in that the laser system comprises a pulsed laser source.

10. The machine according to claim 1, characterized in that the laser beam can be orientated with an oblique or orthogonal incidence onto the part or parts.

11. The machine according to claim 1, characterized in that the transport system is capable of displacing the part or parts in a manner such that two successive treatment zones are contiguous.

12. The machine according to claim 1, characterized in that the laser system comprises a device for correcting the path and/or the shape and/or the focussing of the laser beam.

13. The machine according to claim 1, characterized in that the transport system comprises a position-encoding device.

14. The machine according to claim 1, characterized in that the transport system comprises a turntable intended to support one or more parts.

15. The machine according to claim 14, characterized in that the transport system comprises turrets mounted on the turntable and intended to receive one or more parts.

16. The machine according to claim 15, characterized in that the turrets are movable in rotation with respect to the turntable.

17. The machine according to claim 14, characterized in that the transport system comprises platens which are rotatably mounted on the turrets and intended to support the parts.

18. The machine according to claim 14, characterized in that the laser system is disposed laterally.

19. The machine according to claim 1, characterized in that the transport system comprises a longitudinal transport device intended to support one or more parts.

20. The machine according to claim 1, characterized in that the transport system comprises visual marks and an optical sensor which is capable of cooperating with the marks.

21. A method for the treatment of parts having different shapes, the method comprising:
a) a step for vacuuming a chamber in which the part or parts are located, then a combination of the following steps:
b) a step for laser treatment of the part or parts, and
c) a step for low pressure plasma treatment of the part or parts, and/or
d) a step for carrying out vacuum deposition onto one or more of the parts;
characterized in that the various steps are carried out in the same machine which has been adapted to treat parts having different shapes.

22. The method in accordance with claim 21, characterized in that steps b), c) and d) are carried out selectively in order to treat the part or parts, either separately from the other steps or simultaneously with one or more of the other steps.

23. The method according to claim 21, characterized in that the steps b), c), d) or combinations thereof are carried out in accordance with a sequence of use which can be set, with a variable order of use and/or a variable number of uses.
